(19) United States
(12) Patent Application Publication
(10) Pub. No.: US 2026/0309627 A1
(43) Pub. Date: Oct. 8, 2026

(54) METHOD AND KIT FOR DETECTING A TARGET ANALYTE

(71) Applicant: University of Massachusetts, Westborough, MA (US)

(72) Inventors: Lili He, Ludlow, MA (US); Adam Forbes, Amherst, MA (US); Zili Gao, Florence, MA (US)

(73) Assignee: University of Massachusetts, Westborough, MA (US)

(21) Appl. No.: 19/641,615

(22) Filed: Apr. 8, 2026

Related U.S. Application Data
(60) Provisional application No. 63/785,059, filed on Apr. 8, 2025.

(51) Int. Cl. G01N 21/65; B01L 3/00

(52) U.S. Cl. CPC G01N 21/658; B01L 3/508; B01L 2200/021; B01L 2200/025; B01L 2200/0668; B01L 2200/141; B01L 2300/0681; G01N 2201/0221

(57) ABSTRACT

A method of detecting a target analyte in a sample includes providing a porous membrane; pressing a suspension comprising a plurality of metal nanoparticles and a volatile organic solvent into a defined portion of the porous membrane to embed the plurality of nanoparticles in the porous membrane to form a SERS sensing region; pressing the sample into the SERS sensing region; and analyzing the SERS sensing region using surface enhanced Raman spectroscopy. A kit for detecting a target analyte includes a suspension of a plurality of metal nanoparticles and a volatile organic solvent; a porous membrane, wherein the metal nanoparticles are capable of being embedded in a defined portion of the porous membrane; and a detection module configured to retain the porous membrane. The methods and kits described herein are particularly useful for detecting analytes using handheld or portable surface enhanced Raman Spectroscopy.

### FEDERAL RESEARCH STATEMENT

This invention was made with government support under Grant No. R01 Al180243 awarded by the National Institutes of Health. The government has certain rights in the invention.

### CROSS-REFERENCE TO RELATED APPLICATION

This patent document claims priority to earlier filed U.S. Provisional Patent Application Serial No. 63/785,059, filed on Apr. 8, 2025, the entire contents of which are incorporated herein by reference.

### BACKGROUND

### 1. Field of the Invention.

The present patent document is directed to methods for detecting a target analyte and a kit therefore, that is portable, inexpensive, and accurate.

### 2. Background of the Related Art.

Detection of trace chemicals in solid and liquid samples can be achieved by various techniques, for example methods that combine chromatography with mass spectrometry. While sensitive, such methods are labor intensive, time consuming, and costly. They are also not portable.

Surface enhanced Raman Spectroscopy (SERS) offers an attractive alternative for chemical analysis. SERS is a powerful technique for chemical and biomolecular identification. Typically, a SERS analysis involves spotting a small (e.g., microliter) volume of sample onto a SERS substrate, allowing it to dry, and then detecting the Raman scattering. Due to the optical and chemical enhancement of nanostructures, single molecule identification has been demonstrated with SERS. Unfortunately, the high cost and complications associated with the fabrication of conventional SERS-active substrates have prevented the wide use of SERS.

Despite ongoing research and development, there remains a continuing need in the art for simple and low-cost SERS systems. It would be particularly advantageous to provide a method and system that is portable and capable of being used in the field.

### SUMMARY

An aspect of the present disclosure is a method of detecting a target analyte in a sample, the method comprising: providing a porous membrane; pressing a suspension comprising a plurality of metal nanoparticles and a volatile organic solvent into a defined portion of the porous membrane to embed the plurality of nanoparticles in the porous membrane to form a SERS sensing region; pressing the sample into the SERS sensing region; and analyzing the SERS sensing region using surface enhanced Raman spectroscopy (SERS).

Another aspect of the present disclosure is a kit for detecting a target analyte comprising: a suspension comprising a plurality of metal nanoparticles and a volatile organic solvent; a porous membrane, wherein the metal nanoparticles are capable of being embedded in a defined portion of the porous membrane; and a detection module configured to retain the porous membrane.

Another aspect of the present disclosure is a method of detecting a target analyte, the method comprising: providing a kit comprising a suspension comprising a plurality of metal nanoparticles and a volatile organic solvent; a porous membrane, wherein the metal nanoparticles are capable of being embedded in a defined portion of the porous membrane; and a detection module configured to retain the porous membrane; retaining the porous membrane in the detection module; pressing the suspension comprising the plurality of metal nanoparticles and the volatile organic solvent into a defined portion of the porous membrane via the pipette guide of the detection module to embed the plurality of metal nanoparticles in the porous membrane to form a SERS sensing region; pressing the sample into the SERS sensing region via the pipette guide; and analyzing the SERS sensing region using surface enhanced Raman spectroscopy (SERS).

The above described and other features are exemplified by the following figures and detailed description.

### BRIEF DESCRIPTION OF THE DRAWINGS

These and other features, aspects, and advantages of the present invention will become better understood with reference to the following description, appended claims, and accompanying drawings where:

FIG. 1 is a schematic illustration of the process of preparing a paper-based SERS substrate and analyzing a sample on the substrate using portable Raman spectroscopy.

FIG. 2 is an illustration of components of the detection module according to an aspect of the present disclosure.

FIG. 3 shows optical microscopy images (top) and scanning electron microscopy (SEM) images (bottom) for plain filter paper (left) and nanoparticle-containing SERS substrates (right).

FIG. 4 shows Raman depth plots for control filter paper and a nanoparticle-containing SERS substrate.

FIG. 5 shows Raman spectra of red dye #3, red dye #40, and mixtures thereof obtained using a system according to an aspect of the present disclosure.

FIG. 6 shows Raman spectra of a salmonella-containing sample obtained using a system according to an aspect of the present disclosure.

FIGS. 7A and 7B show a schematic illustration of a method for analyzing a mosquito using a system according to an aspect of the present disclosure.

FIG. 8 shows Raman spectra for mosquitos of varying ages (3 days, 7 days, 14 days, and 21 days) obtained using a handheld spectrometer (left) and a bench top spectrometer (right).

FIG. 9 shows a confusion matrix displaying the classification accuracy based on individual spectral readings.

FIG. 10A shows a t-SNE plot for the different age groups of mosquitos.

FIG. 10B shows a table showing multiple spectral readings from a single mosquito, combined.

FIG. 11 shows a confusion matrix showing the accuracy of classifying individual spectra into one of the four categories (R3, R7, S3, S7).

FIG. 12A shows a t-SNE plot visualizes the data clusters of FIG. 11.

FIG. 12B shows a table aggregating multiple readings for an individual mosquito.

### DETAILED DESCRIPTION

The use of a handheld Raman spectrometer for SERS is challenging because of the difficulty in focusing on the SERS substrate and low resolution. To overcome these and other technical limitations of existing systems, the present inventors have developed a SERS substrate and a sample holder which is simple, low cost, and portable. The SERS substrate can be made from a porous substrate such as filter paper, and metal nanoparticles can be pressed into the filter paper, providing highly localized nanoparticles embedded in the filter paper to a depth of about 50 to 100 micrometers, in an aspect. The SERS substrate and sample holder according to the present disclosure can advantageously enable improved focus for Raman spectroscopy and high signal enhancement. The sample holder according to the present disclosure is designed to provide a facile connection with a handheld Raman spectrometer with a pre-determined rough focal range and a function of holding a sample liquid for single use. The sample holder can also be 3D printed and easily customized to adapt to specifications of varying spectrometers. A significant improvement is therefore provided by the present disclosure.

Accordingly, an aspect of the present disclosure is a method of detecting a target analyte in a sample. The method comprises providing a porous membrane, pressing a suspension comprising a plurality of metal nanoparticles and a volatile organic solvent into a defined portion of the porous membrane to embed the plurality of nanoparticles in the porous membrane to form a SERS sensing region; pressing the sample into the SERS sensing region; and analyzing the SERS sensing region using surface enhanced Raman spectroscopy (SERS).

The porous membrane is not particularly limited provided that it has sufficient porosity for embedding the metal nanoparticles. The porous membrane can be flexible or rigid. In some aspects, the porous membrane is a polymeric membrane which includes one or more polymers. Exemplary polymers can include but are not limited to polyethylene, polypropylene, nylon, polyvinylidene fluoride (PVDF), polyvinyl chloride, polystyrene, polytetrafluoroethylene, thermoplastic polyurethane, cellulose, modified cellulose, copolymers thereof, or a combination thereof. The porosity of the porous membrane results from the membrane having a plurality of pores, which can range in size from, for example, 100 to 900 nanometers (nm), or 200 to 800 nm, or 300 to 700 nm.

A particular polymer for the porous membrane can be selected based on desired characteristics for the membrane. For example, if a flexible substrate is desired it can be advantageous to select flexible or elastomeric polymer materials.

In a specific aspect, the porous membrane can comprise a filter paper, such as cellulose paper.

In some aspects, the porous membrane can be free of any coating disposed on the surface of the membrane. For example, in some aspects, the porous membrane can be free of a conductive, semi-conductive, or metal-containing containing.

A mixture (e.g., a solution or suspension) comprising a plurality of metal nanoparticles and a volatile organic solvent can be pressed into a defined portion of the porous membrane, embedding the plurality of nanoparticles in the porous membrane to form a SERS sensing region. The metal nanoparticles can comprise metals, metal oxides, mixtures thereof, alloys thereof, and combinations thereof. The metal nanoparticles can preferably be semi-conductive metal nanoparticles. Suitable metal nanoparticles can be nanoparticles comprising a noble metal, and can be, for example, gold nanoparticles (e.g., elemental gold nanoparticles), silver nanoparticles (e.g., elemental silver nanoparticles, AgO₂ nanoparticles), copper nanoparticles (e.g., elemental copper nanoparticles), platinum nanoparticles (e.g., elemental platinum nanoparticles), or a combination thereof. In a specific aspect, the metal nanoparticles comprise silver or gold, preferably silver nanoparticles. Other SERS active materials may also be used to provide the nanoparticles for use in the present disclosure.

Suitable nanoparticles have at least one dimension (e.g., diameter for spherical particles) that is 1 to 1000 nanometers, for example 1 to 500 nm, or 1 to 250 nm, or 1 to 100 nm, or 50 to 500 nm, or 100 to 1000 nm, or 100 to 500 nm. In some aspects, the metal nanoparticles are substantially spherical in shape.

During SERS analysis, at least one target analyte will bind to at least one metal nanoparticles. In some aspects, a target analyte may not possess the requisite affinity for the metal nanoparticle. Accordingly, in some aspects, it can be desirable to modify the surface of the metal nanoparticles. For example, in some aspects, the metal nanoparticles can have a coating disposed on a surface thereof, can be surface modified with a particular functional group, or both. The surface coating can be applied to 50 to 100% of the surface area of the nanoparticle, for example 60 to 90% surface area, less than, equal to, or greater than 50% surface area, or 55% surface area, or 60% surface area, or 65% surface area, or 70% surface area, or 75% surface area, or 80% surface area, or 85% surface area, or 90% surface area, or 95% surface area, or 100% surface area. The surface coating, when present, can include many suitable coatings. Non-limiting examples of suitable coatings can include an antibody, an analyte specific targeting group, a compound having an end group, and combinations thereof, in which the compound having an end group includes at least one of a nucleophilic end group, electrophilic end group, a hydrophobic end group, and a hydrophilic end group.

The metal nanoparticles can be provided in the form of a liquid solution or suspension including a volatile organic solvent. The volatile organic solvent is selected such that it is compatible with the metal nanoparticles and that it evaporates sufficiently fast. For example, suitable organic solvents can allow for a deposited volume (e.g., 10 microliters) to dry within, for example, 30 seconds. In an aspect, the volatile organic solvent can have an evaporation rate (e.g., as determined according to ASTM D3539-11 relative to the evaporation rate of n-butyl acetate under the same conditions) of greater than or equal to 1.3 (e.g., greater than 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3, 3, 3.4, 3.5, 3.6, 3.7, 3.8, 3.9, 4.0, 4.1, 4.2, 4.3, 4.4, 4.5, 4.6, 4.7, 4.8, 4.9 or 5.0). Exemplary volatile organic solvents can include, but are not limited to, acetone, ethanol, methanol, isopropanol, hexane, and the like, or combinations thereof. In some aspects, the volatile organic solvent is acetone. A suitable solvent can also contribute to aggregation of the metal nanoparticles on drying.

The metal nanoparticles can be embedded in the membrane with any desired pattern. Thus, in some aspects, an array of SERS sensing regions can be provided on a single membrane. In some aspects, each membrane can comprise a single SERS sensing region.

The present inventors have discovered that the method by which the metal nanoparticles are embedded in the substrate can affect the results of the subsequent SERS measurement. In particular, the present inventors have discovered that the metal nanoparticles should be pressed into the surface of the membrane, for example by pressing a pipette tip to the defined portion of the surface of the porous membrane and expelling the suspension through the pipette tip to embed the plurality of metal nanoparticles in the porous membrane. Such a pressing technique provides a well-defined SERS sensing region having a high concentration of metal nanoparticles, increasing the sensitivity of the substrate during a SERS measurement. In contrast, simply dropping the solvated metal nanoparticles onto the membrane results in spreading, yielding a large, inconsistent SERS sensing region. The inventors have further discovered that the pressing technique described herein can also embed the metal nanoparticles into the porous membrane to a depth of, for example, up to 100 micrometers, or up to 90 micrometers, or up to 80 micrometers, or up to 70 micrometers, or up to 60 micrometers, or up to 50 micrometers.

SERS measurements can be acquired by depositing a sample onto the SERS sensing region. Preferably, the sample is pressed into the sensing region using the same method as described previously for the metal nanoparticles. For example, in an aspect, pressing the sample into the SERS sensing region can comprise pressing a pipette tip to the SERS sensing region and expelling the sample through the pipette tip.

Due to careful selection of the volatile organic solvent used to deposit the metal nanoparticles, the required amount of time between depositing the metal nanoparticles and depositing the sample can be advantageously reduced. For example, in some aspects, an elapsed time between depositing the suspension and contacting with the sample is less than 10 minutes, or less than 5 minutes, or less than 1 minute. Accordingly, there is no need for a prolonged drying step in the manufacture of the SERS substrates described herein, enabling them to be prepared quickly and efficiently on demand and in the field, alleviating concerns about pre-prepared substrates suffering from oxidation of metal nanoparticles, resulting in decreased performance.

Analyzing the sample can be by any suitable Raman spectrometer. Typical SERS detection systems can include a spectrometer and an excitation source (e.g., a laser). Advantageously, the analyzing can be by using a handheld or portable SERS module in some aspects.

The target analyte can interact with at least one metal nanoparticle through a covalent bond, an ionic bond, a van der Waals force, a hydrogen bond, or a mechanical connection. Any of these interactions can be enhanced through a surface coating on the nanoparticles, as discussed herein. After contact between the target analyte and the substrate a corresponding surface enhanced Raman spectrum or surface enhanced infrared spectrum can be generated.

The present inventors have also found that it can be advantageous to employ the method described herein in conjunction with a particular detection module configured to align the SERS substrate with the excitation source, improving focus and sensitivity, particularly in a portable or handheld device. For example, the detection module can comprise a sample holder base, a sample holder, a sample tamper, and a pipette guide. The sample holder base can be configured to align the SERS sensing region of the porous membrane with a light source in a Raman spectrometer. The sample holder is disposed in the sample holder base configured to maintain a predetermined distance between the light source and the SERS sensing region of the porous membrane. The sample tamper can be configured to prevent deformation of the porous membrane (e.g., during a SERS measurement). It will be appreciated that the sample tamper may not be needed in all instances, and thus is removable and optional. The pipette guide can be configured to aid in accurate application of the sample to the SERS sensing region, and can be removable during the SERS measurement.

The method described herein can be useful for detection of a variety of target analytes. For example, the target analyte can comprise a food component, a nutrient, a bacteria, a pathogen, a pesticide (e.g., thiram or thiabendazole) a biological molecule such as a protein, a deoxyribonucleic acid sequence, a ribonucleic acid sequence, an amino acid, a peptide, a nucleotide, a nucleoside, a neurotransmitter, a biomarker, a hormone, or a steroid. In some aspects, the target analyte can comprise a synthetic molecule, such as a dye (e.g., red #3, red #40, or the like). In some aspects the target analyte may be a biomarker for a given disease, such as a biomarker for dementia, cancer, heart disease, or neuromuscular disorder. In some aspects, the sample can comprise a mosquito and the sample can be analyzed to determine age or infection status of the mosquito, as well as insecticide resistance. The sample may contain a single target analyte, or a mixture of two or more target analytes.

Another aspect of the present disclosure is a kit for detecting a target analyte. The kit can be used with a Raman spectrometer, for example a portable or handheld Raman spectrometer, for detection of the target analyte. The kit comprises a suspension comprising a plurality of metal nanoparticles dispersed or dissolved in a volatile organic solvent; a porous membrane, wherein the metal nanoparticles are capable of being embedded in a defined portion of the porous membrane; and a detection module configured to retain the porous membrane (e.g., in a Raman spectrometer).

All above-described variations on the metal nanoparticles, solvent, and porous membrane discussed in the context of the disclosed method also apply to the kit of the present disclosure. In some aspects, the porous membrane comprises polyethylene, polypropylene, nylon, polyvinylidene fluoride (PVDF), polyvinyl chloride, polystyrene, polytetrafluoroethylene, thermoplastic polyurethane, cellulose, modified cellulose, copolymers thereof, or a combination thereof. In a specific aspect, the porous membrane can be a filter paper, for example a cellulose filter paper. The metal nanoparticles can comprise, for example, gold, silver, copper, platinum, or a combination thereof, and preferably are silver nanoparticles. The volatile organic solvent can preferably comprise acetone. The detection module can be as already described herein and comprises a sample holder base configured to align a SERS sensing region of the porous membrane with a light source in a Raman spectrometer; a sample holder disposed in the sample holder base configured to maintain a predetermined distance between the light source and the SERS sensing region of the porous membrane; a sample tamper configured to prevent deformation of the porous membrane; and a pipette guide for accurate application of the sample to the SERS sensing region.

Advantageously, the kit can be used to detect a target analyte on demand in a given environment. Accordingly, another aspect of the present disclosure is a method of detecting a target analyte using the kit provided herein. For example, the method can comprise providing the kit of the present disclosure, assembling the detection module, wherein the porous membrane is retained in the detection module. The SERS sensing region can then be prepared on the membrane by pressing the suspension comprising the plurality of metal nanoparticles and the volatile organic solvent into a defined portion of the porous membrane via the pipette guide of the detection module to embed the plurality of metal nanoparticles in the porous membrane to form the SERS sensing region. The sample can subsequently be pressed into the SERS sensing region using the pipette guide, and Raman spectroscopy can be used to analyze the sample. In a specific aspect, the porous membrane can comprise filter paper (e.g., cellulose paper); the metal nanoparticles can comprise silver nanoparticles; the volatile organic solvent can comprise acetone; the plurality of metal nanoparticles can be embedded in the porous membrane to a depth of up to 100 micrometers; an elapsed time between depositing the suspension and contacting with the sample can be less than 10 minutes, or less than 5 minutes, or less than 1 minute; and analyzing the SERS sensing region can comprise using a handheld or portable SERS module.

This disclosure is further illustrated by the following examples, which are non-limiting.

### Examples

Erythrosine (FD&C Red #3) is a synthetic colorant that was banned in food products by the Food and Drug Administration in Jan. 2025 because it was found to cause cancer in rats. Detecting Red #3 in food is an emerging issue for the food industry, as other red colorants can be easily adulterated with Red #3 to enhance the color and appearance of products. Traditional detection methods such as high-performance liquid chromatography and UV-Visible spectrophotometry require bulky benchtop instrumentation and time-consuming sample preparation. Surface Enhanced Raman Spectroscopy (SERS) is a molecular detection technique that enables rapid, sensitive, and portable detection of Red #3 in food products. However, portable SERS detection remains a challenge because most SERS substrates are incompatible with portable Raman spectrometers.

To overcome the limitations of current SERS substrates, concentrated aqueous silver nanoparticles (AgNPs) in 80% acetone were pipetted onto filter paper, embedding the AgNPs throughout the paper, forming the substrate. The substrate takes only 30 seconds to prepare and costs less than 10 cents to produce at the lab scale. A detection module was designed and 3D-printed to optimize the distance between the laser and the sample, simplify instrument operation, and prevent cross contamination between samples.

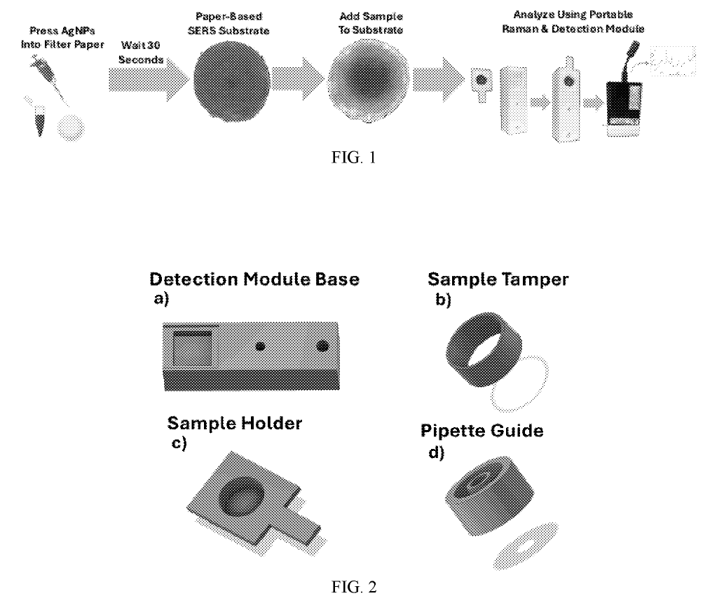

A schematic illustration of SERS substrate preparation and analysis of a sample by handheld Raman spectrometer is shown in FIG. 1.

Using the SERS substrate and sample holder, Red #3 was detected at both 10% and 50% adulteration levels in solutions of Red #40, carmine, and red radish extract (an anthocyanin). Additionally, Red #3 was detected in sprinkles and mint candy containing both Red #40 and Red #3. The total sample preparation time is about 5 minutes and provides specific identification of Red #3 by its SERS spectral fingerprint, showing significant improvement over current detection methods.

Experimental details follow.

Paper SERS substrates were fabricated by first synthesizing silver nanoparticles. Specifically, silver nitrate was heated at 350° C. with stirring until boiling, then sodium citrate was added. The mixture was removed from heat and stirred for 20 minutes, followed by 100x concentration using centrifugation. The obtained concentrate was then diluted 20x with acetone, and the silver nanoparticles were redispersed by sonication to provide the silver nanoparticle dispersion.

As noted above, a detection module was designed and 3D printed. It is noted that the particular detection module used in the present examples was designed to accommodate the particular Raman spectrometer used in these experiments, and that the detection module can be adjusted in design to adapt to other spectrometers. A schematic illustration of the detection module components is shown in FIG. 2. As shown in FIG. 2, the detection module base (a) is adapted to align the spectrometer with the substrate. The sample holder (c) is configured to maintain the substrate at an optimal distance from the light source. The pipette guide (d) is configured to ease sample preparation and enhance reproducibility by allowing an used to apply silver nanoparticles and the sample to the same spot on the substrate. The sample tamper (b) is configured to prevent the wet substrate from curling or otherwise deforming during data collection.

The silver nanoparticle dispersion was pipetted (e.g., pressed) onto filter paper to prepare the substrate. FIG. 3 shows optical microscope images of plain filter paper (a) and the paper SERS substrate (b) including the silver nanoparticles at 20x magnification. Also shown in FIG. 3 are scanning electron microscope (SEM) images of plain filter paper (c) and the paper SERS substrate (d) including the silver nanoparticles at 10,000x magnification.

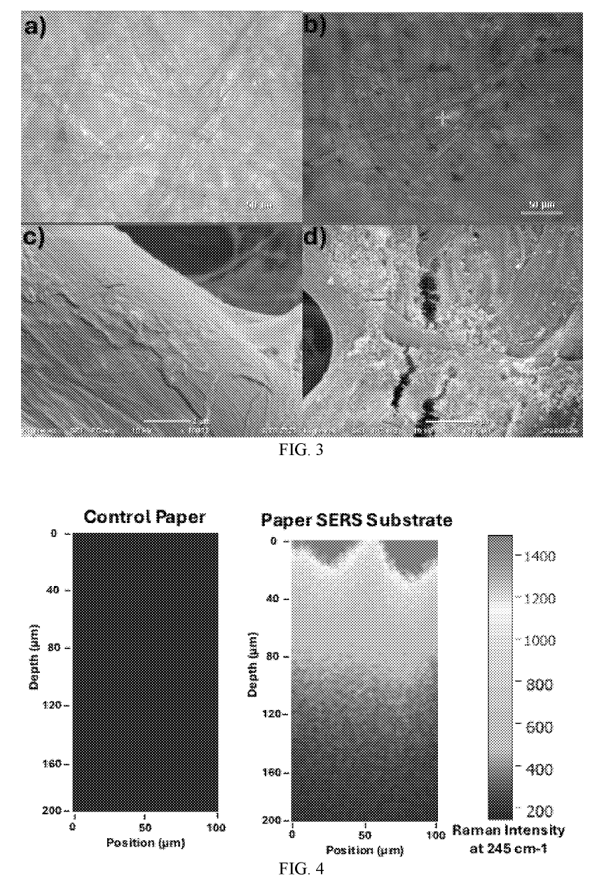

Raman depth mapping was used to characterize the penetration of the silver nanoparticles into the filter paper. FIG. 4 shows Raman depth maps of blank filter paper (left) and the paper-based SERS substrate (right), confirming the presence of the silver nanoparticles, and further indicating that the particles could penetrate the paper substrate to a depth of up to approximately 100 micrometers.

The paper-based SERS substrate and the designed sample holder were used to characterize the presence of red dye #3 in candy. The substrate was prepared by pipetting (e.g., pressing) 10 microliters of the silver nanoparticle dispersion into filter paper. Red candy was crushed using a mortar and pestle to form a fine powder. The powdered candy (200 milligrams) was combined with 800 microliters of pH 3 sodium acetate buffer, and 10 microliters of the sample was pipetted (e.g., pressed) into the substrate including the silver nanoparticles. Raman spectroscopy was used to analyze the sample. Red dye # 3 was detected using this method, and further was distinguishable from other red food colorants such as red dye #40, as shown in FIG. 5.

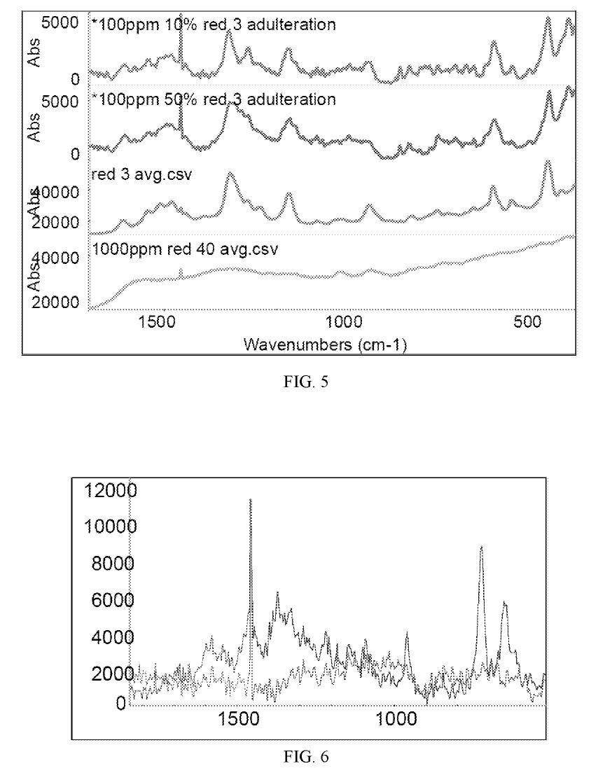

The present inventors have also found that the substrate can be useful for detecting bacteria. For example, 6 microliters of a 10⁹ CFU/mL Salmonella sample was pressed into the SERS substrate of the present disclosure. FIG. 6 shows the resulting Raman spectra of Salmonella on the substrate of the present disclosure (purple trace) compared to the background of the substrate only (red trace), confirming the presence of Salmonella.

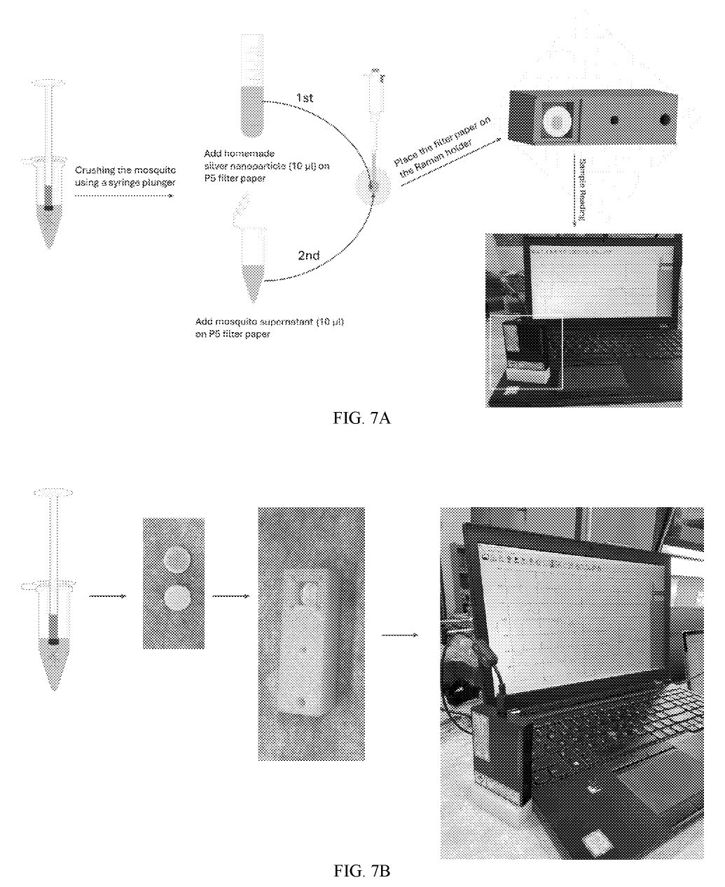

Finally, the present SERS substrate was used in mosquito analysis according to the process illustrated in FIGS. 7A and 7B. Mosquitos of varying ages (e.g., 3 days, 7 days, 14 days, and 21 days) were crushed (separately) in 100 to 1000 microliters of a solvent such as water or ethanol. Silver nanoparticle dispersion (10 microliters) was pressed into a filter paper, and subsequently, 10 microliters of the supernatant of the mosquito mixture was pressed to the filter paper. The SERS substrate was placed on the Raman holder and analyzed to determine age and infection status of the mosquito, and susceptibility to insecticides. This protocol demonstrates a simple, field-deployable method for mosquito surveillance. Traditional laboratory techniques often require bulky, expensive equipment and complex sample preparation. By using a portable spectrometer and a straightforward filter paper-based preparation method, this approach brings advanced molecular analysis out of the lab. The addition of silver nanoparticles is a critical step, as it significantly boosts the Raman signal, allowing for the detection of subtle biochemical differences between individual mosquitoes.

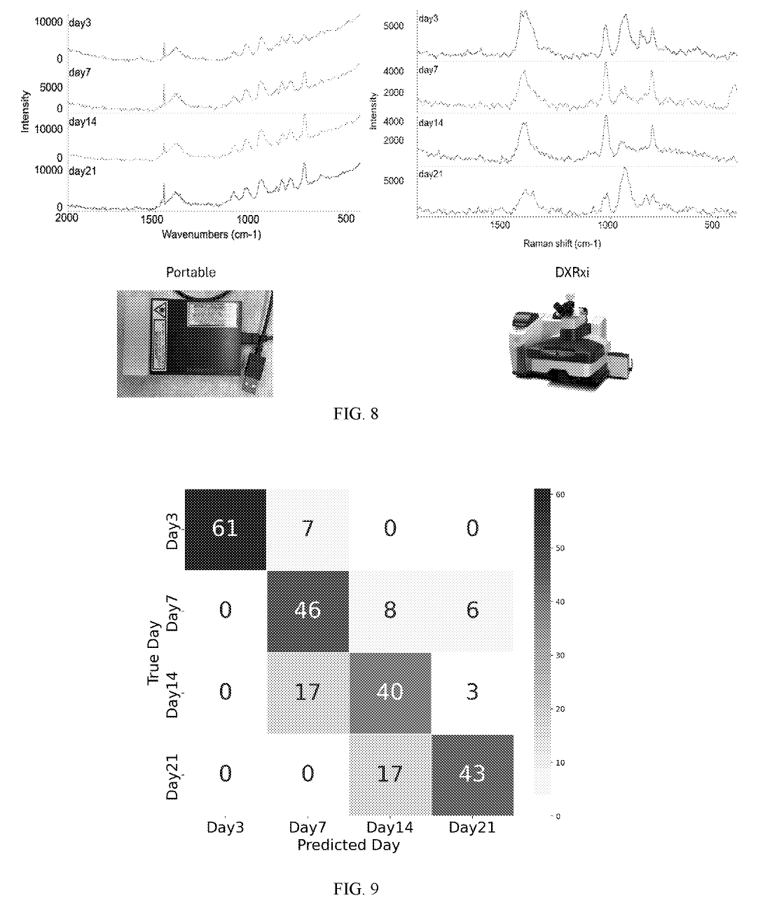

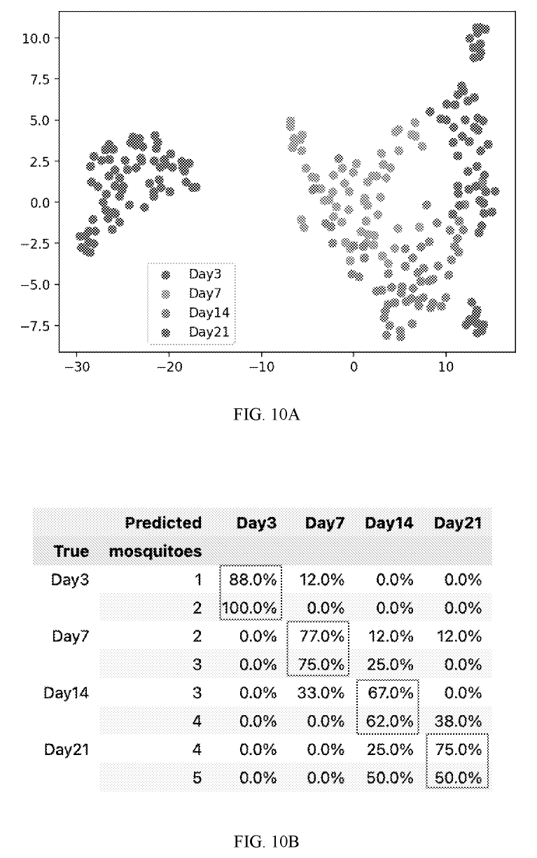

FIG. 8 shows the Raman spectra for the mosquitos of varying ages obtained on a portable Raman spectrometer (left) and a bench top Raman spectrometer (right), showing that the method according to the present disclosure provides very good spectra quality. As shown in FIG. 9, a confusion matrix displaying the classification accuracy based on individual spectral readings. The model correctly identified the mosquito's age 77% of the time. As further shown in FIG. 10A, the t-SNE plot shows distinct clustering for the different age groups. Referring to FIG. 10B, the table shows that when multiple spectral readings from a single mosquito are combined (aggregated), the classification accuracy improves significantly to 87.5% (7 out of 8 mosquitoes correctly identified). Determining the age of mosquitoes is crucial for disease control because only older mosquitoes have lived long enough to incubate and transmit pathogens like malaria or dengue. These results show that the portable Raman system can successfully distinguish between young and old mosquitoes based on their chemical fingerprints. The improvement in accuracy when aggregating data highlights the reliability of taking multiple readings per sample, making this a promising tool for rapid age-grading in the field.

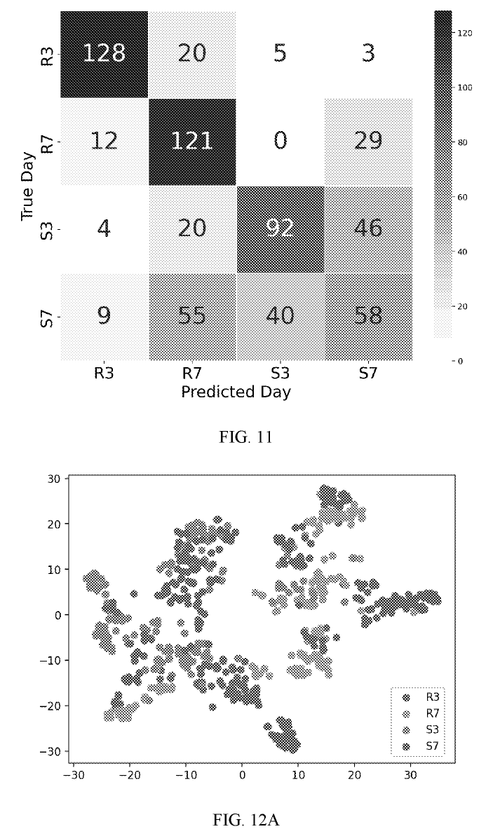

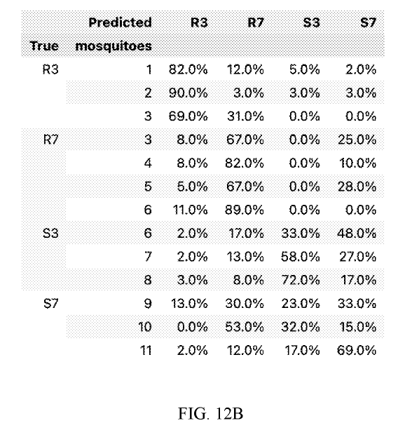

Referring to FIGS. 11, 12A and 12B, the system’s ability to differentiate between mosquitoes that are resistant (R) or susceptible (S) to insecticides, tested at two different ages (Day 3 and Day 7). Referring to FIG. 11, a confusion matrix showing the accuracy of classifying individual spectra into one of the four categories (R3, R7, S3, S7) is shown, where the overall accuracy at this level is 62%. FIG. 12A The t-SNE plot visualizes the data clusters. Referring to FIG. 12B, aggregating multiple readings for an individual mosquito significantly boosts the overall accuracy to 85%.

Monitoring insecticide resistance is a major challenge in global health, as mosquitoes continually adapt to the chemicals used to control them. This demonstrates that the portable Raman setup can detect the underlying biochemical differences between resistant and susceptible mosquito populations. Although the spectral data is more complex and overlapping compared to simple age classification, combining multiple measurements per mosquito yields a high level of accuracy. This suggests the technology could be a valuable, rapid tool for monitoring resistance trends in local mosquito populations, helping public health officials choose the most effective control methods.

Thus the present inventors have developed a simple and sensitive paper SERS substrate compatible with a handheld Raman spectrometer that can be fabricated very quickly (e.g., 30 seconds or less).

This disclosure further encompasses the following aspects.

Aspect 1: A method of detecting a target analyte in a sample, the method comprising: providing a porous membrane; pressing a suspension comprising a plurality of metal nanoparticles and a volatile organic solvent into a defined portion of the porous membrane to embed the plurality of nanoparticles in the porous membrane to form a SERS sensing region; pressing the sample into the SERS sensing region; and analyzing the SERS sensing region using surface enhanced Raman spectroscopy (SERS).

Aspect 2: The method of aspect 1, wherein the porous membrane comprises polyethylene, polypropylene, nylon, polyvinylidene fluoride (PVDF), polyvinyl chloride, polystyrene, polytetrafluoroethylene, thermoplastic polyurethane, cellulose, modified cellulose, copolymers thereof, or a combination thereof.

Aspect 3: The method of aspect 1 or 2, wherein the porous membrane is filter paper.

Aspect 4: The method of any of aspects 1 to 3, wherein the metal nanoparticles comprise gold, silver, copper, platinum, or a combination there, preferably wherein the metal nanoparticles are silver nanoparticles.

Aspect 5: The method of any of aspects 1 to 4, wherein the volatile organic solvent has an evaporation rate of greater than or equal to 1.3 determined according to ASTM D3539-11 relative to the evaporation rate of n-butyl acetate, measured under the same conditions, preferably wherein the volatile organic solvent comprises acetone, ethanol, methanol, isopropanol, hexane, and the like, or combinations thereof, more preferably wherein the volatile organic solvent comprises acetone.

Aspect 6: The method of any of aspects 1 to 5, wherein pressing the suspension comprises pressing a pipette tip to the defined portion of the surface of the porous membrane and expelling the suspension through the pipette tip to embed the plurality of metal nanoparticles in the porous membrane.

Aspect 7: The method of any of aspects 1 to 6, wherein the plurality of metal nanoparticles are embedded in the porous membrane to a depth of up to 100 micrometers.

Aspect 8: The method of any of aspects 1 to 7, wherein pressing the sample into the SERS sensing region comprises pressing a pipette tip to the SERS sensing region and expelling the sample through the pipette tip.

Aspect 9: The method of any of aspects 1 to 8, wherein an elapsed time between depositing the suspension and contacting with the sample is less than 10 minutes, or less than 5 minutes, or less than 1 minute.

Aspect 10: The method of any of aspects 1 to 9, wherein the analyzing using SERS comprises using a handheld or portable SERS module.

Aspect 11: The method of any of aspects 1 to 10, wherein the porous membrane is retained in a detection module comprising a sample holder base configured to align the SERS sensing region of the porous membrane with a light source in a Raman spectrometer; a sample holder disposed in the sample holder base configured to maintain a predetermined distance between the light source and the SERS sensing region of the porous membrane; a sample tamper configured to prevent deformation of the porous membrane; and a removable pipette guide for accurate application of the sample to the SERS sensing region.

Aspect 12: The method of any of aspects 1 to 10, wherein the target analyte comprises a food component, a bacteria, a nutrient, a pathogen, a biological molecule, a dye, a biomarker, or a mosquito.

Aspect 13: A kit for detecting a target analyte comprising: a suspension comprising a plurality of metal nanoparticles and a volatile organic solvent; a porous membrane, wherein the metal nanoparticles are capable of being embedded in a defined portion of the porous membrane; and a detection module configured to retain the porous membrane.

Aspect 14: The kit of aspect 13, wherein the porous membrane comprises polyethylene, polypropylene, nylon, polyvinylidene fluoride (PVDF), polyvinyl chloride, polystyrene, polytetrafluoroethylene, thermoplastic polyurethane, cellulose, modified cellulose, copolymers thereof, or a combination thereof.

Aspect 15: The kit of aspect 13 or 14, wherein the porous membrane is filter paper.

Aspect 16: The kit of any of aspects 13 to 15, wherein the metal nanoparticles comprise gold, silver, copper, platinum, or a combination there, preferably wherein the metal nanoparticles are silver nanoparticles.

Aspect 17: The kit of any of aspects 13 to 16, wherein the volatile organic solvent has an evaporation rate of greater than or equal to 1.3 determined according to ASTM D3539-11 relative to the evaporation rate of n-butyl acetate, measured under the same conditions, preferably wherein the volatile organic solvent comprises acetone, ethanol, methanol, isopropanol, hexane, and the like, or combinations thereof, more preferably wherein the volatile organic solvent comprises acetone.

Aspect 18: The kit of any of aspects 13 to 17, wherein the detection module comprises: a sample holder base configured to align a SERS sensing region of the porous membrane with a light source in a Raman spectrometer; a sample holder disposed in the sample holder base configured to maintain a predetermined distance between the light source and the SERS sensing region of the porous membrane; a sample tamper configured to prevent deformation of the porous membrane; and a removable pipette guide for accurate application of the sample to the SERS sensing region.

Aspect 19: A method of detecting a target analyte, the method comprising: providing a kit comprising a suspension comprising a plurality of metal nanoparticles and a volatile organic solvent; a porous membrane, wherein the metal nanoparticles are capable of being embedded in a defined portion of the porous membrane; and a detection module configured to retain the porous membrane; retaining the porous membrane in the detection module; pressing the suspension comprising the plurality of metal nanoparticles and the volatile organic solvent into a defined portion of the porous membrane via the pipette guide of the detection module to embed the plurality of metal nanoparticles in the porous membrane to form a SERS sensing region; pressing the sample into the SERS sensing region via the pipette guide; and analyzing the SERS sensing region using surface enhanced Raman spectroscopy (SERS).

Aspect 20: The method of aspect 19, wherein the porous membrane comprises filter paper; the metal nanoparticles comprise silver nanoparticles; the volatile organic solvent comprises acetone; the plurality of metal nanoparticles are embedded in the porous membrane to a depth of up to 100 micrometers; an elapsed time between depositing the suspension and contacting with the sample is less than 10 minutes, or less than 5 minutes, or less than 1 minute; and analyzing the SERS sensing region comprises using a handheld or portable SERS module.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of detecting a target analyte in a sample, the method comprising:
providing a porous membrane;
pressing a suspension comprising a plurality of metal nanoparticles and a volatile organic solvent into a defined portion of the porous membrane to embed the plurality of nanoparticles in the porous membrane to form a SERS sensing region;
pressing the sample into the SERS sensing region; and
analyzing the SERS sensing region using surface enhanced Raman spectroscopy.

2. The method of claim 1, wherein the porous membrane comprises polyethylene, polypropylene, nylon, polyvinylidene fluoride (PVDF), polyvinyl chloride, polystyrene, polytetrafluoroethylene, thermoplastic polyurethane, cellulose, modified cellulose, copolymers thereof, or a combination thereof.

3. The method of claim 1, wherein the porous membrane is filter paper.

4. The method of claim 1, wherein the metal nanoparticles comprise gold, silver, copper, platinum, or a combination there, preferably wherein the metal nanoparticles are silver nanoparticles.

5. The method of claim 1, wherein the volatile organic solvent has an evaporation rate of greater than or equal to 1.3 determined according to ASTM D3539-11 relative to the evaporation rate of n-butyl acetate, measured under the same conditions,
preferably wherein the volatile organic solvent comprises acetone, ethanol, methanol, isopropanol, hexane, and the like, or combinations thereof,
more preferably wherein the volatile organic solvent comprises acetone.

6. The method of claim 1, wherein pressing the suspension comprises pressing a pipette tip to the defined portion of the surface of the porous membrane and expelling the suspension through the pipette tip to embed the plurality of metal nanoparticles in the porous membrane.

7. The method of claim 1, wherein the plurality of metal nanoparticles are embedded in the porous membrane to a depth of up to 100 micrometers.

8. The method of claim 1, wherein pressing the sample into the SERS sensing region comprises pressing a pipette tip to the SERS sensing region and expelling the sample through the pipette tip.

9. The method of claim 1, wherein an elapsed time between depositing the suspension and contacting with the sample is less than 10 minutes, or less than 5 minutes, or less than 1 minute.

10. The method of claim 1, wherein the analyzing using SERS comprises using a handheld or portable SERS module.

11. The method of claim 1, wherein the porous membrane is retained in a detection module comprising
a sample holder base configured to align the SERS sensing region of the porous membrane with a light source in a Raman spectrometer;
a sample holder disposed in the sample holder base configured to maintain a predetermined distance between the light source and the SERS sensing region of the porous membrane;
a sample tamper configured to prevent deformation of the porous membrane; and
a removable pipette guide for accurate application of the sample to the SERS sensing region.

12. The method of claim 1, wherein the target analyte comprises a food component, a bacteria, a nutrient, a pathogen, a biological molecule, a dye, a biomarker, or a mosquito.

13. A kit for detecting a target analyte comprising:
a suspension comprising a plurality of metal nanoparticles and a volatile organic solvent;
a porous membrane, wherein the metal nanoparticles are capable of being embedded in a defined portion of the porous membrane; and
a detection module configured to retain the porous membrane.

14. The kit of claim 13, wherein the porous membrane comprises polyethylene, polypropylene, nylon, polyvinylidene fluoride (PVDF), polyvinyl chloride, polystyrene, polytetrafluoroethylene, thermoplastic polyurethane, cellulose, modified cellulose, copolymers thereof, or a combination thereof.

15. The kit of claim 13, wherein the porous membrane is filter paper.

16. The kit of claim 13, wherein the metal nanoparticles comprise gold, silver, copper, platinum, or a combination there, preferably wherein the metal nanoparticles are silver nanoparticles.

17. The kit of claim 13, wherein the volatile organic solvent has an evaporation rate of greater than or equal to 1.3 determined according to ASTM D3539-11 relative to the evaporation rate of n-butyl acetate, measured under the same conditions,
preferably wherein the volatile organic solvent comprises acetone, ethanol, methanol, isopropanol, hexane, and the like, or combinations thereof,
more preferably wherein the volatile organic solvent comprises acetone.

18. The kit of claim 13, wherein the detection module comprises:
a sample holder base configured to align a SERS sensing region of the porous membrane with a light source in a Raman spectrometer;
a sample holder disposed in the sample holder base configured to maintain a predetermined distance between the light source and the SERS sensing region of the porous membrane;
a sample tamper configured to prevent deformation of the porous membrane; and
a removable pipette guide for accurate application of the sample to the SERS sensing region.

19. A method of detecting a target analyte, the method comprising:
providing a kit comprising
a suspension comprising a plurality of metal nanoparticles and a volatile organic solvent;
a porous membrane, wherein the metal nanoparticles are capable of being embedded in a defined portion of the porous membrane; and
a detection module configured to retain the porous membrane;
retaining the porous membrane in the detection module;
pressing the suspension comprising the plurality of metal nanoparticles and the volatile organic solvent into a defined portion of the porous membrane via the pipette guide of the detection module to embed the plurality of metal nanoparticles in the porous membrane to form a SERS sensing region;
pressing the sample into the SERS sensing region via the pipette guide; and
analyzing the SERS sensing region using surface enhanced Raman spectroscopy.

20. The method of claim 19, wherein
the porous membrane comprises filter paper;
the metal nanoparticles comprise silver nanoparticles;
the volatile organic solvent comprises acetone;
the plurality of metal nanoparticles are embedded in the porous membrane to a depth of up to 100 micrometers;
an elapsed time between depositing the suspension and contacting with the sample is less than 10 minutes, or less than 5 minutes, or less than 1 minute; and
analyzing the SERS sensing region comprises using a handheld or portable SERS module.
